(19) United States
(12) Patent Application Publication
(10) Pub. No.: US 2025/0023586 A1
(43) Pub. Date: Jan. 16, 2025

(54) RADIO FREQUENCY CIRCUIT AND COMMUNICATION APPARATUS

(71) Applicant: Murata Manufacturing Co., Ltd., Nagaokakyo-shi (JP)

(72) Inventors: Motoji TSUDA, Nagaokakyo-shi (JP); Kei MATSUTANI, Nagaokakyo-shi (JP); Kanta MOTOKI, Nagaokakyo-shi (JP); Reiji NAKAJIMA, Nagaokakyo-shi (JP); Yuji TAKEMATSU, Nagaokakyo-shi (JP)

(73) Assignee: Murata Manufacturing Co., Ltd., Nagaokakyo-shi (JP)

(21) Appl. No.: 18/896,950

(22) Filed: Sep. 26, 2024

Related U.S. Application Data
(63) Continuation of application No. PCT/JP2023/013697, filed on Mar. 31, 2023.

(30) Foreign Application Priority Data
Jun. 13, 2022 (JP) 2022-095301

(51) Int. Cl. H04B 1/00; H04B 1/44; H04L 5/14

(52) U.S. Cl. CPC H04B 1/006; H04B 1/44; H04L 5/1461

(57) ABSTRACT

A radio frequency circuit includes an antenna connection terminal, an input terminal, an output terminal, a filter having a pass band including at least part of a transmission band of Band A for FDD, a filter having a pass band including at least part of a reception band of the Band A, and a switch that includes terminals. The antenna connection terminal is connected to the terminal. The filter is connected between the terminal and the input terminal. The filter is connected between the terminal and the output terminal. The switch is configured to switch between first connection, second connection, and third connection. In the first connection, the terminal is connected to the terminal and the terminal is not connected to the terminal. In the second connection, the terminal is connected to the terminal and the terminal is not connected to the terminal.

### CROSS-REFERENCE TO RELATED APPLICATIONS

This is a continuation application of PCT/JP2023/013697, filed on Mar. 31, 2023, designating the United States of America, which is based on and claims priority to Japanese Patent Application No. JP 2022-095301 filed on Jun. 13, 2022. The entire contents of the above-identified applications, including the specifications, drawings and claims, are incorporated herein by reference in their entirety.

### TECHNICAL FIELD

The present disclosure relates to a radio frequency circuit and a communication apparatus.

### BACKGROUND ART

In 3GPP (registered trademark) (3rd Generation Partnership Project), power classes (for example, power classes 1, 1.5, 2, etc.) that allow higher maximum output powers have been considered in mobile communication systems. In Patent Document 1, a radio frequency circuit that can be used in mobile communication systems is disclosed.

### CITATION LIST

### Patent Document

Patent Document 1: Japanese Unexamined Patent Application Publication No. 2021-016049

### SUMMARY OF DISCLOSURE

### Technical Problem

In the case where such high power classes are applied to bands for frequency division duplex (FDD), high isolation between a transmission filter and a reception filter is required, and loss may increase in the transmission filter and/or reception filter.

Accordingly, the present disclosure provides a radio frequency circuit and a communication apparatus that are capable of suppressing an increase of loss in a transmission filter and a reception filter for a band for FDD.

### Solution to Problem

A radio frequency circuit according to an aspect of the present disclosure includes an antenna connection terminal, an input terminal, an output terminal, a first filter having a pass band including at least part of a transmission band of a first band for frequency division duplex, a second filter having a pass band including at least part of a reception band of the first band, and a first switch that includes a first terminal, a second terminal, and a third terminal. The antenna connection terminal is connected to the first terminal. The first filter is connected between the second terminal and the input terminal. The second filter is connected between the third terminal and the output terminal. The first switch is configured to switch between first connection, second connection, and third connection. In the first connection, the first terminal is connected to the second terminal and the first terminal is not connected to the third terminal. In the second connection, the first terminal is connected to the third terminal and the first terminal is not connected to the second terminal. In the third connection, the first terminal is connected to the second terminal and the third terminal at the same time.

A radio frequency circuit according to an aspect of the present disclosure includes a first antenna connection terminal, a second antenna connection terminal, an input terminal, an output terminal, a first filter having a pass band including at least part of a transmission band of a first band for frequency division duplex, a second filter having a pass band including at least part of a reception band of the first band, and a first switch that includes a first terminal, a second terminal, a third terminal, and a fourth terminal. The first antenna connection terminal is connected to the first terminal. The second antenna connection terminal is connected to the second terminal. The first filter is connected between the third terminal and the input terminal. The second filter is connected between the fourth terminal and the output terminal. The first switch is configured to switch between first connection, second connection, and third connection. In the first connection, one of the first terminal and the second terminal is connected to the third terminal and neither the first terminal nor the second terminal is connected to the fourth terminal. In the second connection, one of the first terminal and the second terminal is connected to the fourth terminal and neither the first terminal nor the second terminal is connected to the third terminal. In the third connection, one of the first terminal and the second terminal is connected to the third terminal and the other one of the first terminal and the second terminal is connected to the fourth terminal.

### Advantageous Effects of Disclosure

With a radio frequency circuit according to an aspect of the present disclosure, an increase of loss in a transmission filter and a reception filter for a band for FDD can be suppressed.

### BRIEF DESCRIPTION OF DRAWINGS

FIG. 1 is a circuit configuration diagram of a communication apparatus according to a first embodiment.

FIG. 2 is a diagram illustrating transmission of a signal of Band A in the case of a high power class in the communication apparatus according to the first embodiment.

FIG. 3 is a diagram illustrating reception of a signal of the Band A in the case of the high power class in the communication apparatus according to the first embodiment.

FIG. 4 is a diagram illustrating transmission and reception of signals of the Band A in the case of a low power class in the communication apparatus according to the first embodiment.

FIG. 5 is a circuit configuration diagram of a communication apparatus according to a second embodiment.

FIG. 6 is a diagram illustrating transmission of a signal of the Band A in the case of the high power class in the communication apparatus according to the second embodiment.

FIG. 7 is a diagram illustrating reception of a signal of the Band A in the case of the high power class in the communication apparatus according to the second embodiment.

FIG. 8 is a diagram illustrating transmission and reception of signals of the Band A in the case of the low power class in the communication apparatus according to the second embodiment.

FIG. 9 is a circuit configuration diagram of a communication apparatus according to a third embodiment.

FIG. 10 is a diagram illustrating transmission of a signal of the Band A in the case of the high power class in the communication apparatus according to the third embodiment.

FIG. 11 is a diagram illustrating reception of a signal of the Band A in the case of the high power class in the communication apparatus according to the third embodiment.

FIG. 12 is a diagram illustrating transmission and reception of signals of the Band A in the case of the low power class in the communication apparatus according to the third embodiment.

FIG. 13 is a circuit configuration diagram of a communication apparatus according to a fourth embodiment.

FIG. 14 is a diagram illustrating transmission of a signal of the Band A in the case of the high power class in the communication apparatus according to the fourth embodiment.

FIG. 15 is a diagram illustrating reception of a signal of the Band A in the case of the high power class in the communication apparatus according to the fourth embodiment.

FIG. 16 is a diagram illustrating transmission and reception of signals of the Band A in the case of the low power class in the communication apparatus according to the fourth embodiment.

### DESCRIPTION OF EMBODIMENTS

Hereinafter, embodiments of the present disclosure will be described in detail with reference to drawings. The embodiments described below each illustrate a comprehensive or specific example. Numerical values, shapes, materials, component elements, arrangements of the component elements, manners in which the component elements are connected, and so on illustrated in the embodiments described below are merely examples and are not intended to limit the present disclosure.

The drawings are schematic diagrams in which emphasis, omission, or ratio adjustment is performed in an appropriate manner in order that the present disclosure is illustrated. The drawings are not necessarily strictly illustrated and may differ from actual shapes, positional relationships, and ratios. In the drawings, substantially the same configurations are denoted by the same reference signs, and repetitive description may be omitted or simplified.

In a circuit configuration of the present disclosure, “being connected” not only represents being directly connected by a connection terminal and/or a wire conductor but also includes being electrically connected with another circuit element interposed therebetween. “Being connected between A and B” means being connected to both A and B between A and B, and means being connected in series to a path connecting A to B. “A is connected to B and C at the same time” means that at least part of a first period during which A is connected to B temporally overlap at least part of a second period during which A is connected to C and is not limited to a state in which the first period and the second period completely overlap (that is, a state in which the start and end of the first period and the start and end of the second period are the same).

In the present disclosure, a “transmission band” represents a frequency band used for transmission in a communication apparatus. Furthermore, a “reception band” represents a frequency band used for reception in the communication apparatus. For example, different frequency bands are used as a transmission band and a reception band in the case of FDD bands, and the same frequency band is used as a transmission band a reception band in the case of time division duplex (TDD) bands. In particular, in the case where a communication apparatus functions as a user terminal (UE: user equipment) of a cellular communication system, in the case of FDD bands, an uplink operation band can be used as a transmission band and a downlink operation band can be used as a reception band. In contrast, in the case where a communication apparatus functions as a base station (BS) of a cellular communication system, in the case of FDD bands, a downlink operation band can be used as a transmission band and an uplink operation band can be used as a reception band.

In the present disclosure, a pass band of a filter is a part of a frequency spectrum that is transmitted through the filter and is defined as a frequency range in which output power is not attenuated from the maximum output power by 3 dB or more. Thus, an upper limit frequency and a lower limit frequency of a pass band of a band pass filter are frequencies at points where output power is attenuated from the maximum output power by 3 dB.

In the present disclosure, a “terminal” represents a point at which a conductor inside an element terminates. In the case where the impedance of a path between elements is sufficiently low, a terminal is not only construed as a single point but also as an arbitrary point in the path between the elements or the entire path.

### First Embodiment

### 1.1 Circuit Configuration of Communication Apparatus 5

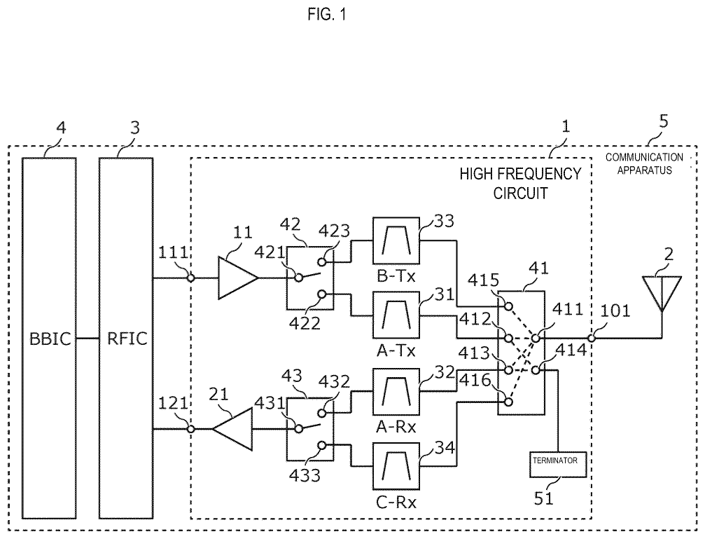

First, a circuit configuration of a communication apparatus 5 according to an embodiment will be described with reference to FIG. 1. FIG. 1 is a circuit configuration diagram of the communication apparatus 5 according to this embodiment.

The communication apparatus 5 corresponds to a UE in a cellular communication system and is typically a mobile phone, a smartphone, a tablet computer, a wearable device, or the like. The communication apparatus 5 may be an IoT (Internet of Things) sensor device, a medical/healthcare device, a vehicle, an unmanned aerial vehicle (UAV) (a so-called drone), or an automated guided vehicle (AGV). Furthermore, the communication apparatus 5 may be used as a BS in the cellular communication system.

As illustrated in FIG. 1, the communication apparatus 5 includes a radio frequency circuit 1, an antenna 2, an RFIC (Radio Frequency Integrated Circuit) 3, and a BBIC (Baseband Integrated Circuit) 4.

The radio frequency circuit 1 transfers radio frequency signals between the antenna 2 and the RFIC 3. The internal configuration of the radio frequency circuit 1 will be described later.

The antenna 2 is connected to an antenna connection terminal 101 of the radio frequency circuit 1. The antenna 2 is capable of transmitting a radio frequency signal output from the radio frequency circuit 1 and capable of receiving a radio frequency signal from the outside and then outputting the radio frequency signal to the radio frequency circuit 1.

The RFIC 3 is an example of a signal processing circuit that processes a radio frequency signal. Specifically, the RFIC 3 is capable of performing signal processing, such as up-conversion, for a transmission signal input from the BBIC 4 and outputting a radio frequency transmission signal generated by the signal processing to a transmission path of the radio frequency circuit 1. Furthermore, the RFIC 3 is capable of performing signal processing, such as down-conversion, for a radio frequency reception signal input through a reception path of the radio frequency circuit 1 and outputting a reception signal generated by the signal processing to the BBIC 4. Furthermore, the RFIC 3 may include a controller that controls a switch, an amplifier, and the like included in the radio frequency circuit 1. Part of or the entire function of the RFIC 3 as a controller may be implemented outside the RFIC 3 or may be implemented on, for example, the BBIC 4 and/or the radio frequency circuit 1.

The BBIC 4 is a baseband signal processing circuit that performs signal processing using an intermediate frequency band that is lower than frequencies of radio frequency signals transmitted from the radio frequency circuit 1. For example, image signals for image display and/or audio signals for conversation via a speaker are used as signals processed by the BBIC 4.

In the communication apparatus 5 according to this embodiment, the antenna 2 and the BBIC 4 are not essential component elements.

### 1.2 Circuit Configuration of Radio Frequency Circuit 1

Next, a circuit configuration of the radio frequency circuit 1 will be described with reference to FIG. 1. The radio frequency circuit 1 includes a power amplifier 11, a low noise amplifier 21, filters 31 to 34, switches 41 to 43, a terminator 51, the antenna connection terminal 101, an input terminal 111, and an output terminal 121. Hereinafter, component elements of the radio frequency circuit 1 will be described in order.

The antenna connection terminal 101 is connected to the antenna 2 outside the radio frequency circuit 1 and is connected to the switch 41 inside the radio frequency circuit 1.

The input terminal 111 is a terminal for receiving a radio frequency signal from the outside of the radio frequency circuit 1. In FIG. 1, the input terminal 111 is connected to the RFIC 3 outside the radio frequency circuit 1 and is connected to the power amplifier 11 inside the radio frequency circuit 1.

The power amplifier 11 is an active circuit that obtains, based on electric power supplied from a power supply, an output signal with an energy greater than energy of an input signal (transmission signal). The power amplifier 11 includes an amplifying transistor and may further include an inductor and/or a capacitor. The internal configuration of the power amplifier 11 is not particularly limited. For example, the power amplifier 11 may be a multi-stage amplifier or may be an amplifier of a differential amplification type or a Doherty amplifier.

In this embodiment, the power amplifier 11 is connected between the input terminal 111 and the filters 31 and 33 and is capable of amplifying transmission signals of Band A and Band B. Specifically, an input end of the power amplifier 11 is connected to the input terminal 111. An output end of the power amplifier 11 is connected to the filters 31 and 33 with the switch 42 interposed therebetween.

The low noise amplifier 21 is an active circuit that obtains, based on electric power supplied from the power supply, an output signal with an energy greater than energy of an input signal (reception signal). The low noise amplifier 21 includes an amplifying transistor and may further include an inductor and/or a capacitor. The internal configuration of the low noise amplifier 21 is not particularly limited.

In this embodiment, the low noise amplifier 21 is connected between the output terminal 121 and the filters 32 and 34 and is capable of amplifying reception signals of the Band A and Band C. Specifically, an input end of the low noise amplifier 21 is connected to the filters 32 and 34 with the switch 43 interposed therebetween. An output end of the low noise amplifier 21 is connected to the output terminal 121.

The filter 31 (A-Tx) is an example of a first filter and is a band pass filter that has a pass band including at least part of the transmission band of the Band A for FDD. That is, the pass band of the filter 31 may include only part of the transmission band of the Band A or may include the whole transmission band of the Band A. One end of the filter 31 is connected to the output end of the power amplifier 11 with the switch 42 interposed therebetween. The other end of the filter 31 is connected to the antenna connection terminal 101 with the switch 41 interposed therebetween.

The filter 32 (A-Rx) is an example of a second filter and is a band pass filter that has a pass band including at least part of the reception band of the Band A for FDD. That is, the pass band of the filter 32 may include only part of the reception band of the Band A or may include the whole reception band of the Band A. One end of the filter 32 is connected to the input end of the low noise amplifier 21 with the switch 43 interposed therebetween. The other end of the filter 32 is connected to the antenna connection terminal 101 with the switch 41 interposed therebetween.

The filter 33 (B-Tx) is an example of a third filter and is a band pass filter that has a pass band including at least part of the transmission band of the Band B. That is, the pass band of the filter 33 may include only part of the transmission band of the Band B or may include the whole transmission band of the Band B. One end of the filter 33 is connected to the output end of the power amplifier 11 with the switch 42 interposed therebetween. The other end of the filter 33 is connected to the antenna connection terminal 101 with the switch 41 interposed therebetween.

The filter 34 (C-Rx) is an example of a fourth filter and is a band pass filter that has a pass band including at least part of the reception band of the Band C. That is, the pass band of the filter 34 may include only part of the reception band of the Band C or may include the whole reception band of the Band C. One end of the filter 34 is connected to the input end of the low noise amplifier 21 with the switch 43 interposed therebetween. The other end of the filter 34 is connected to the antenna connection terminal 101 with the switch 41 interposed therebetween.

The filters 31 to 34 may be a surface acoustic wave (SAW) filters, bulk acoustic wave (BAW) filters, LC resonance filters, or dielectric filters. However, the filters 31 to 34 are not limited to the filters mentioned above.

The Bands A to C are frequency bands for communication systems established using radio access technology (RAT). The Bands A to C are defined in advance by standards organizations or other bodies (for example, 3GPP, IEEE (Institute of Electrical and Electronics Engineers), etc.). Examples of communication systems include a 5GNR (5th Generation New Radio) system, an LTE (Long Term Evolution) system, a WLAN (Wireless Local Area Network) system, and the like.

The Band A is an example of a first band is a band for FDD. For example, Band 66 for LTE or n66 for 5GNR may be used as the Band A. However, the Band A is not limited to these bands.

The Band B is an example of a second band and may be a band for FDD, a band for Time Division Duplex (TDD), or a band for SUL (Supplementary Uplink). For example, Band 25 for LTE or n25 for 5GNR may be used as the Band B. However, the Band B is not limited to these bands.

The Band C is an example of a third band and may be a band for FDD, a band for TDD, or a band for SDL (Supplementary Downlink). For example, Band 30 for LTE or n30 for 5GNR may be used as the Band C. However, the Band C is not limited to these bands.

The switch 41 is an example of a first switch and is connected between the antenna connection terminal 101 and the filters 31 to 34. Specifically, the switch 41 includes terminals 411 to 416. The terminal 411 is an example of a first terminal and is connected to the antenna connection terminal 101. The terminal 412 is an example of a second terminal and is connected to the filter 31. The terminal 413 is an example of a third terminal and is connected to the filter 32. The terminal 414 is an example of a fourth terminal and is connected to the terminator 51. The terminal 415 is an example of a fifth terminal and is connected to the filter 33. The terminal 416 is an example of a sixth terminal and is connected to the filter 34.

In this connection arrangement, the switch 41 is capable of, for example, based on a control signal from the RFIC 3, connecting the terminals 411 and 414 to the terminals 412, 413, 415, and 416. The switch 41 is a switch circuit of a multi-connection type.

Specifically, the switch 41 is capable of switching at least between first connection, second connection, and third connection. In the first connection, the terminal 411 is connected to the terminal 412 and the terminal 411 is not connected to the terminal 413. In this case, the terminal 414 may be connected to the terminal 413 as desired. In the second connection, the terminal 411 is not connected to the terminal 412 and the terminal 411 is connected to the terminal 413. In this case, the terminal 414 may be connected to the terminal 412 as desired. In the third connection, the terminal 411 is connected to the terminals 412 and 413 at the same time.

In this embodiment, in the condition where a first power class is applied to the Band A, the switch 41 is capable of temporally switching between the first connection and the second connection. In contrast, in the condition where a second power class is applied to the Band A, the switch 41 is capable of maintaining the third connection.

Power class is a classification of the output power of a terminal defined by, for example, the maximum output power, and a power class with a smaller value allows a higher maximum output power. For example, in the case of 3GPP, the maximum output power of the power class 1 is 31 dBm, the maximum output power of the power class 1.5 is 29 dBm, the maximum output power of the power class 2 is 26 dBm, and the maximum output power of the power class 3 is 23 dBm.

The maximum output power of a terminal is defined by an output power at an antenna end of the terminal. The maximum output power of a terminal is measured using, for example, a method defined by 3GPP or other methods. For example, in FIG. 1, the maximum output power is measured by measuring power radiated from the antenna 2. Instead of measuring radiated power, the output power of the antenna 2 may be measured by providing a terminal near the antenna 2 and connecting a measurement device (for example, a spectral analyzer) to the terminal.

The first power class is a power class that is defined by the maximum output power equal to or higher than a predetermined power and is called a high power class herein. The second power class is a power class that is defined by the maximum output power lower than the predetermined power and is called a low power class herein. The predetermined power may be determined in advance experimentally and/or empirically and is not particularly limited. For example, in the case where 26 dBm is used as the predetermined power, the high power class includes the power classes, 1, 1.5, and 2 and the low power class includes the power class 3. Power classes are not limited to those mentioned above. If a new power class is defined, the new power class may also be classified into the high power class or the low power class.

The switch 42 is an example of a second switch and is connected between the power amplifier 11 and the filters 31 and 33. Specifically, the switch 42 includes terminals 421 to 423. The terminal 421 is connected to the output end of the power amplifier 11. The terminal 422 is connected to the filter 31. The terminal 423 is connected to the filter 33.

In this connection arrangement, the switch 42 is capable of, for example, based on a control signal from the RFIC 3, exclusively connecting the terminal 421 to the terminal 422 or 423. That is, the switch 42 is capable of switching between connection between the power amplifier 11 and the filter 31 and connection between the power amplifier 11 and the filter 33. The switch 42 is, for example, a switch circuit of an SPDT (Single-Pole Double-Throw) type.

The switch 43 is an example of a third switch and is connected between the low noise amplifier 21 and the filters 32 and 34. Specifically, the switch 43 includes terminals 431 to 433. The terminal 431 is connected to the input end of the low noise amplifier 21. The terminal 432 is connected to the filter 32. The terminal 433 is connected to the filter 34.

In this connection arrangement, the switch 43 is capable of, for example, based on a control signal from the RFIC 3, exclusively connecting the terminal 431 to the terminal 432 or 433. That is, the switch 43 is capable of switching between connection between the low noise amplifier 21 and the filter 32 and connection between the low noise amplifier 21 and the filter 34. The switch 43 is, for example, a switch circuit of the SPDT type.

The switches 41 to 43 described above may be implemented in a single semiconductor integrated circuit. The switches 41 to 43 may be separately implemented in a plurality of semiconductor integrated circuits.

The terminator 51 is connected to the terminal 414 of the switch 41 and is configured to be capable of absorbing and consuming radio frequency signals. For example, a 50 Q resistor may be used as the terminator 51.

The circuit configuration of the radio frequency circuit 1 in FIG. 1 is an example and the circuit configuration of the radio frequency circuit 1 is not limited to the circuit configuration illustrated in FIG. 1. The radio frequency circuit 1 only needs to include at least the filters 31 and 32, the switch 41, the antenna connection terminal 101, the input terminal 111, and the output terminal 121 and does not necessarily include other circuit elements. For example, the radio frequency circuit 1 does not necessarily include the terminator 51. In this case, the switch 41 does not necessarily include the terminal 414. Furthermore, for example, the radio frequency circuit 1 does not necessarily include the filter 33 and/or the filter 34. In this case, the switch 41 does not necessarily include the terminal 415 and/or the terminal 416. Furthermore, the radio frequency circuit 1 may include, instead of the power amplifier 11 and the switch 42, two power amplifiers connected to the filters 31 and 33. Similarly, the radio frequency circuit 1 may include, instead of the low noise amplifier 21 and the switch 43, two low noise amplifiers connected to the filters 32 and 34.

### 1.3 Transmission and Reception in Band A in Case of Each Power Class

Next, transmission and reception in the Band A in the case of each power class in the communication apparatus 5 according to this embodiment will be described.

### 1.3.1 Transmission and Reception in Band A in Case of High Power Class

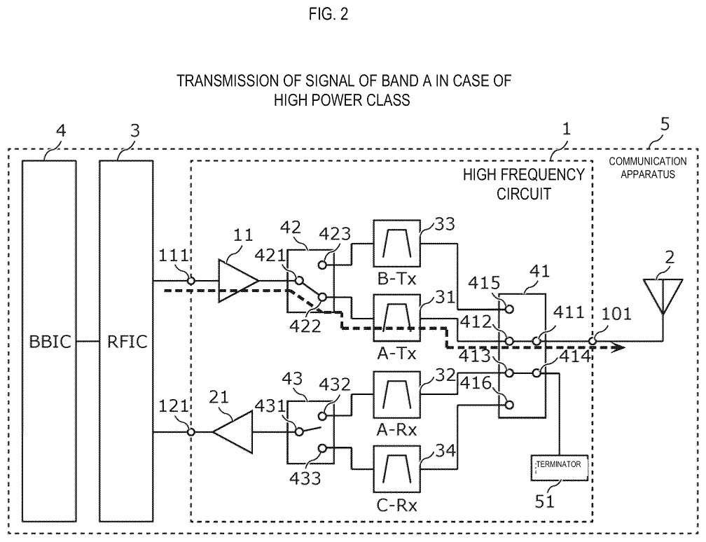

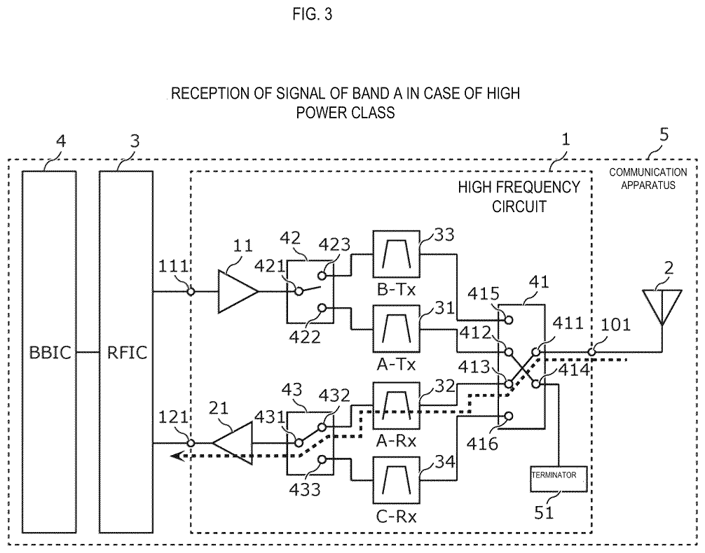

First, transmission and reception in the Band A in the case of the high power class will be described with reference to FIGS. 2 and 3. FIG. 2 is a diagram illustrating transmission of a signal of the Band A in the case of the high power class in the communication apparatus 5 according to this embodiment. FIG. 3 is a diagram illustrating reception of a signal of the Band A in the case of the high power class in the communication apparatus 5 according to this embodiment.

Transmission and reception of signals in the high power class means transmission and reception of signals in a condition that the maximum output power defined by the high power class is allowed. That is, in transmission of signals in the high power class, not only radio frequency signals with an output power equal to the maximum output power of the high power class but also radio frequency signals with an output power less than the maximum output power of the high power class can be transmitted.

In the case of the high power class, the RFIC 3 controls each switch of the radio frequency circuit 1 so that switching between transmission and reception can be performed in an exclusive manner. Specifically, the switch 41 switches between the first connection (see FIG. 2) in which the terminal 411 is connected to the terminal 412 and the terminal 414 is connected to the terminal 413 and the second connection (see FIG. 3) in which the terminal 411 is connected to the terminal 413 and the terminal 414 is connected to the terminal 412. Connection between the terminal 414 and the terminal 413 in the first connection and connection between the terminal 414 and the terminal 412 in the second connection are not essential but are optional.

As a result, in transmission of a signal of the Band A in the case of the high power class, as illustrated in FIG. 2, a transmission signal of the Band A from the RFIC 3 input to the input terminal 111 is amplified by the power amplifier 11 and is transmitted through the switch 42, the filter 31, the switch 41, and the antenna connection terminal 101 to the antenna 2.

In contrast, in reception of a signal of the Band A in the case of the high power class, as illustrated in FIG. 3, a reception signal of the Band A from the antenna 2 input to the antenna connection terminal 101 is transmitted through the switch 41, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the high power class, transmission signals and reception signals are separated from each other based on time as well as frequency.

### 1.3.2 Transmission and Reception in Band A in Case of Low Power Class

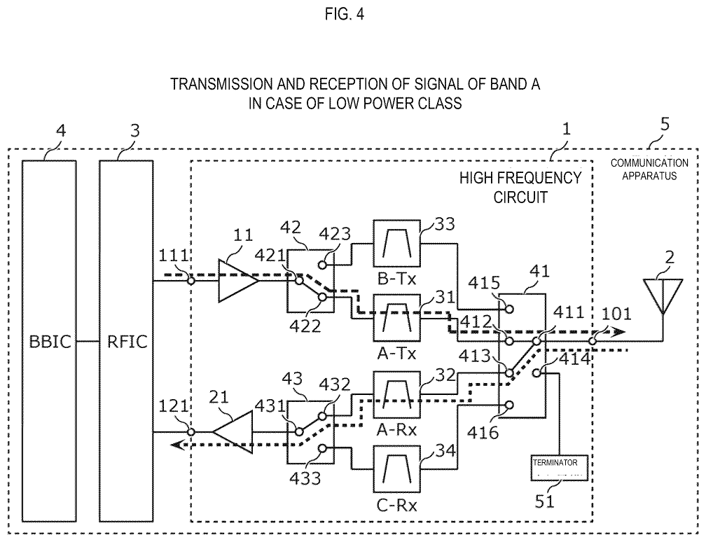

Next, transmission and reception in the Band A in the case of the low power class will be described with reference to FIG. 4. FIG. 4 is a diagram illustrating transmission and reception of signals of the Band A in the case of the low power class in the communication apparatus 5 according to this embodiment.

In the case of the low power class, the RFIC 3 controls each switch of the radio frequency circuit 1 so that transmission and reception can be performed at the same time. Specifically, the switch 41 maintains the third connection (see FIG. 4) in which the terminal 411 is connected to the terminal 412 and the terminal 411 is connected to the terminal 413.

As a result, in transmission of a signal of the Band A in the case of the low power class, as illustrated in FIG. 4, a transmission signal of the Band A from the RFIC 3 input to the input terminal 111 is amplified by the power amplifier 11 and is transmitted through the switch 42, the filter 31, the switch 41, and the antenna connection terminal 101 to the antenna 2.

In contrast, in reception of a signal of the Band A in the case of the low power class, as illustrated in FIG. 4, a reception signal of the Band A from the antenna 2 input to the antenna connection terminal 101 is transmitted through the switch 41, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the low power class, transmission signals and reception signals are separated from each other based on frequency.

### 1.4 Effects and Others

As described above, the radio frequency circuit 1 according to this embodiment includes the antenna connection terminal 101, the input terminal 111, the output terminal 121, the filter 31 having a pass band including at least part of a transmission band of the Band A for FDD, the filter 32 having a pass band including at least part of a reception band of the Band A, and the switch 41 that includes the terminals 411 to 413. The antenna connection terminal 101 is connected to the terminal 411. The filter 31 is connected between the terminal 412 and the input terminal 111. The filter 32 is connected between the terminal 413 and the output terminal 121. The switch 41 is configured to switch between first connection, second connection, and third connection. In the first connection, the terminal 411 is connected to the terminal 412 and the terminal 411 is not connected to the terminal 413. In the second connection, the terminal 411 is connected to the terminal 413 and the terminal 411 is not connected to the terminal 412. In the third connection, the terminal 411 is connected to the terminal 412 and the terminal 413 at the same time.

Accordingly, switching between the first connection and the second connection of the switch 41 is performed temporally. Thus, division and duplex of transmission signals and reception signals of the Band A for FDD can be performed not only based on frequency but also based on time. Therefore, requirements for isolation characteristics between a transmission filter and a reception filter in the Band A can be reduced. That is, design of the filters 31 and 32 can be performed easily, and an increase of loss in the filters 31 and 32 can be suppressed. As a result, output power of the power amplifier 11 can be reduced, and a reduction in noise and an increase in the life of the power supply can be achieved. Furthermore, by maintaining the third connection of the switch 41, communication speed can be improved compared to the case where switching between the first connection and the second connection is performed temporally.

Furthermore, for example, in the radio frequency circuit 1 according to this embodiment, the switch 41 may temporally switch between the first connection and the second connection in the condition where the high power class that is defined by the maximum output power equal to or higher than the predetermined power is applied to the Band A and may maintain the third connection in the condition where the low power class that is defined by the maximum output power lower than the predetermined power is applied to the Band A.

Accordingly, in the case of the high power class, switching between the first connection and the second connection of the switch 41 is performed temporally. Thus, at the time of high output power when there are higher requirements for the isolation characteristics between the filters 31 and 32, the requirements for the isolation characteristics can be reduced. As a result, at the time of high output power, the output power of the power amplifier 11 can be reduced, and effects with respect to a reduction in noise and an increase in the life of the power supply increase. On the contrary, since the third connection of the switch 41 is maintained in the case of the low power class, a reduction in the communication speed can be suppressed at the time of low output power when there are lower requirements for the isolation characteristics.

Furthermore, for example, in the radio frequency circuit 1 according to this embodiment, the switch 41 may further include the terminal 414 that is connected to the terminator 51. In the first connection, the terminal 414 may further be connected to the terminal 413. In the second connection, the terminal 414 may further be connected to the terminal 412.

Accordingly, in the first connection and the second connection, the terminals 412 and 413 of the switch 41 can be terminated when these terminals are not used for transmission of a radio frequency signal, and a further improvement in the isolation characteristics can thus be achieved.

Furthermore, for example, the radio frequency circuit 1 according to this embodiment may further include the power amplifier 11 that is connected between the filter 31 and the input terminal 111.

Accordingly, since the power amplifier 11 is included in the radio frequency circuit 1, amplification of a transmission signal can be implemented in the radio frequency circuit 1.

Furthermore, for example, the radio frequency circuit 1 according to this embodiment may further include the filter 33 having a pass band including at least part of a transmission band of the Band B and the switch 42 that is connected between the power amplifier 11 and the filters 31 and 33. The switch 41 may further include the terminal 415 that is connected to the filter 33. In this case, the switch 42 may be configured to switch between connection between the power amplifier 11 and the filter 31 and connection between the power amplifier 11 and the filter 33.

Accordingly, the power amplifier 11 is connected to the filters 31 and 33 with the switch 42 interposed therebetween. Thus, the power amplifier 11 can be shared by the Bands A and B, which contributes to a reduction in the size of the communication apparatus 5.

Furthermore, for example, the radio frequency circuit 1 according to this embodiment may further include the low noise amplifier 21 that is connected between the filter 32 and the output terminal 121.

Accordingly, since the low noise amplifier 21 is included in the radio frequency circuit 1, amplification of a reception signal can be implemented in the radio frequency circuit 1.

Furthermore, for example, the radio frequency circuit 1 according to this embodiment may further include the filter 34 having a pass band including at least part of a reception band of the Band C and the switch 43 that is connected between the low noise amplifier 21 and the filters 32 and 34. The switch 41 may further include the terminal 416 that is connected to the filter 34. In this case, the switch 43 may be configured to switch between connection between the low noise amplifier 21 and the filter 32 and connection between the low noise amplifier 21 and the filter 34.

Accordingly, the low noise amplifier 21 is connected to the filters 32 and 34 with the switch 43 interposed therebetween. Thus, the low noise amplifier 21 can be shared by the Bands A and C, which contributes to a reduction in the size of the communication apparatus 5.

Furthermore, the communication apparatus 5 according to this embodiment includes the RFIC 3 that processes a radio frequency signal and the radio frequency circuit 1 that transfers the radio frequency signal between the RFIC 3 and the antenna 2.

Accordingly, effects of the radio frequency circuit 1 described above can also be achieved with the communication apparatus 5.

### Second Embodiment

Next, a second embodiment will be described. This embodiment is different from the first embodiment mainly in that two antennas are included in a communication apparatus. Features of this embodiment that are different from the first embodiment will be mainly described below with reference to drawings.

### 2.1 Circuit Configuration of Communication Apparatus 5A

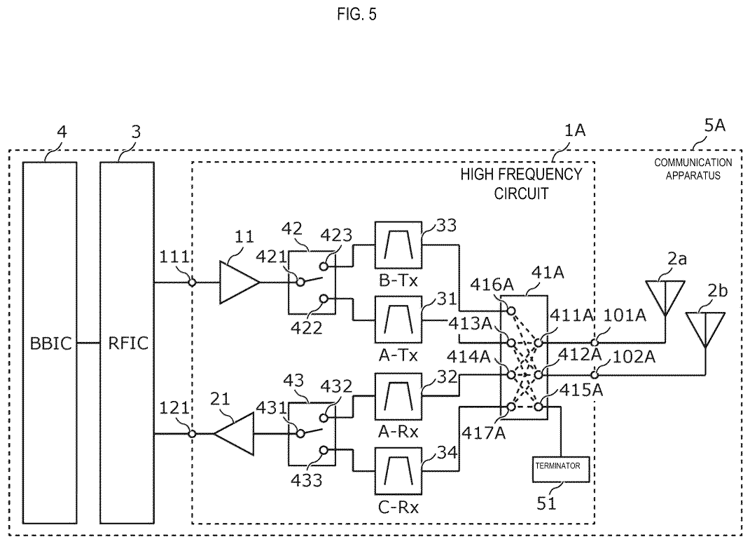

FIG. 5 is a circuit configuration diagram of a communication apparatus 5A according to this embodiment. The communication apparatus 5A according to this embodiment includes antennas 2a and 2b instead of the antenna 2 and a radio frequency circuit 1A instead of the radio frequency circuit 1.

The radio frequency circuit 1A transfers radio frequency signals between the antennas 2a and 2b and the RFIC 3. The internal configuration of the radio frequency circuit 1A will be described later.

The antenna 2a is connected to an antenna connection terminal 101A of the radio frequency circuit 1A. The antenna 2b is connected to an antenna connection terminal 102A of the radio frequency circuit 1A. Each of the antennas 2a and 2b is capable of transmitting a radio frequency signal output from the radio frequency circuit 1A. Each of the antennas 2a and 2b is also capable of receiving a radio frequency signal from the outside and outputting the radio frequency signal to the radio frequency circuit 1A.

In the communication apparatus 5A according to this embodiment, the antennas 2a and 2b and the BBIC 4 are not essential component elements.

### 2.2 Circuit Configuration of Radio Frequency Circuit 1A

Next, a circuit configuration of the radio frequency circuit 1A will be described with reference to FIG. 5. The radio frequency circuit 1A includes the power amplifier 11, the low noise amplifier 21, the filters 31 to 34, switches 41A, 42, and 43, the terminator 51, the antenna connection terminals 101A and 102A, the input terminal 111, and the output terminal 121. Features of component elements of the radio frequency circuit 1A that are different from those of the radio frequency circuit 1 in FIG. 1 will be mainly described below.

The antenna connection terminal 101A is an example of a first antenna connection terminal. The antenna connection terminal 101A is connected to the antenna 2a outside the radio frequency circuit 1A and connected to the switch 41A inside the radio frequency circuit 1A.

The antenna connection terminal 102A is an example of a second antenna connection terminal. The antenna connection terminal 102A is connected to the antenna 2b outside the radio frequency circuit 1A and connected to the switch 41A inside the radio frequency circuit 1A.

The switch 41A is an example of a first switch and is connected between the antenna connection terminals 101A and 102A and the filters 31 to 34. Specifically, the switch 41A includes terminals 411A to 417A. The terminal 411A is an example of a first terminal and is connected to the antenna connection terminal 101A. The terminal 412A is an example of a second terminal and is connected to the antenna connection terminal 102A. The terminal 413A is an example of a third terminal and is connected to the filter 31. The terminal 414A is an example of a fourth terminal and is connected to the filter 32. The terminal 415A is an example of a fifth terminal and is connected to the terminator 51. The terminal 416A is an example of a sixth terminal and is connected to the filter 33. The terminal 417A is an example of a seventh terminal and is connected to the filter 34.

In this connection arrangement, the switch 41A is capable of, for example, based on a control signal from the RFIC 3, connecting the terminals 411A, 412A, and 415A to the terminals 413A, 414A, 416A, and 417A. The switch 41A is a switch circuit of a multi-connection type.

Specifically, the switch 41A is capable of switching at least between first connection, second connection, and third connection. In the first connection, only one of the terminals 411A and 412A is connected to the terminal 413A and neither the terminal 411A nor the terminal 412A is connected to the terminal 414A. In this case, the terminal 415A may be connected to the terminal 414A as desired. In the second connection, neither the terminal 411A nor the terminal 412A is connected to the terminal 413A and only one of the terminals 411A and 412A is connected to the terminal 414A. In this case, the terminal 415A may be connected to the terminal 413A as desired. In the third connection, only one of the terminals 411A and 412A is connected to the terminal 413A and the other one of the terminals 411A and 412A is connected to the terminal 414A.

In this embodiment, in the condition where the high power class is applied to the Band A, the switch 41A is capable of temporally switching between the first connection and the second connection. In contrast, in the condition where the low power class is applied to the Band A, the switch 41A is capable of maintaining the third connection.

The circuit configuration of the radio frequency circuit 1A in FIG. 5 is merely an example and the circuit configuration of the radio frequency circuit 1A is not limited to the circuit configuration illustrated in FIG. 5. The radio frequency circuit 1A only needs to include at least the filters 31 and 32, the switch 41A, the antenna connection terminals 101A and 102A, the input terminal 111, and the output terminal 121 and does not necessarily include other circuit elements. For example, the radio frequency circuit 1A does not necessarily include the terminator 51. In this case, the switch 41A does not necessarily include the terminal 415A. Furthermore, for example, the radio frequency circuit 1A does not necessarily include the filter 33 and/or the filter 34. In this case, the switch 41A does not necessarily include the terminal 416A and/or the terminal 417A. Furthermore, the radio frequency circuit 1A may include, instead of the power amplifier 11 and the switch 42, two power amplifiers connected to the filters 31 and 33. Similarly, the radio frequency circuit 1A may include, instead of the low noise amplifier 21 and the switch 43, two low noise amplifiers connected to the filters 32 and 34.

### 2.3 Transmission and Reception in Band A in Case of Each Power Class

Next, transmission and reception in the Band A in the case of each power class in the communication apparatus 5A according to this embodiment will be described.

### 2.3.1 Transmission and Reception in Band A in Case of High Power Class

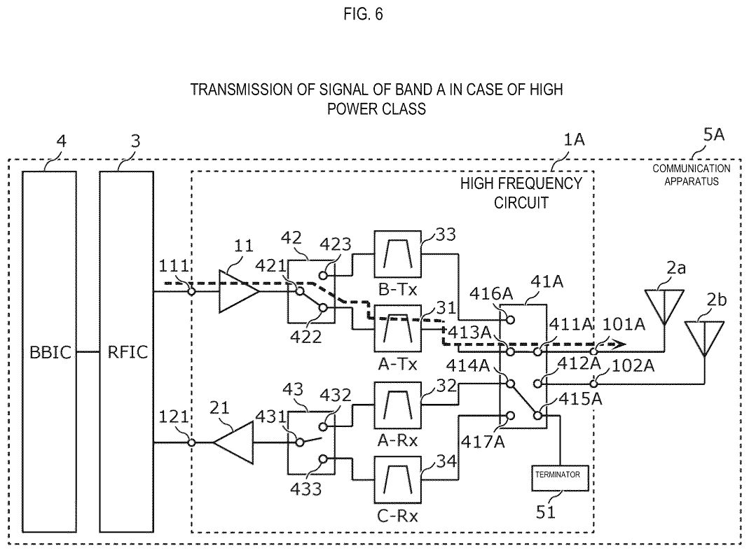

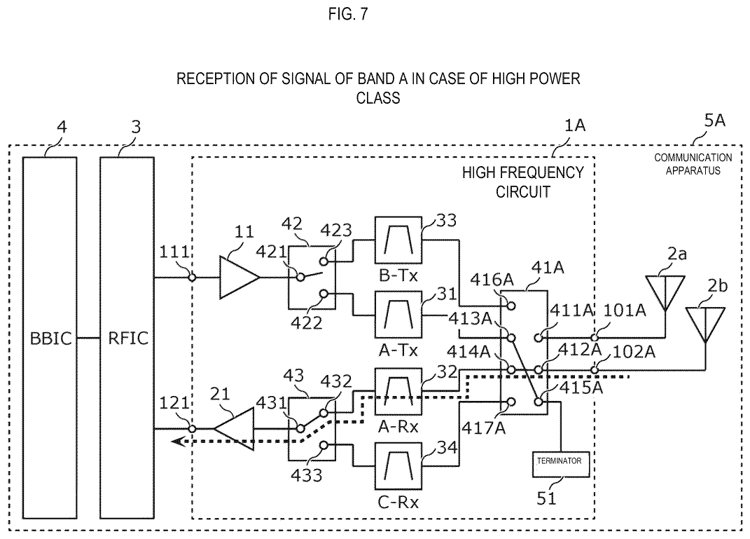

First, transmission and reception in the Band A in the case of the high power class will be described with reference to FIGS. 6 and 7. FIG. 6 is a diagram illustrating transmission of a signal of the Band A in the case of the high power class in the communication apparatus 5A according to this embodiment. FIG. 7 is a diagram illustrating reception of a signal of the Band A in the case of the high power class in the communication apparatus 5A according to this embodiment.

In the case of the high power class, the RFIC 3 controls each switch of the radio frequency circuit 1A so that switching between transmission and reception can be performed in an exclusive manner. Specifically, the switch 41A switches between the first connection (see FIG. 6) in which the terminal 411A is connected to the terminal 413A and the terminal 415A is connected to the terminal 414A and the second connection (see FIG. 7) in which the terminal 412A is connected to the terminal 414A and the terminal 415A is connected to the terminal 413A. Connection between the terminal 415A and the terminal 414A in the first connection and connection between the terminal 415A and the terminal 413A in the second connection are not essential but are optional.

As a result, in transmission of a signal of the Band A in the case of the high power class, as illustrated in FIG. 6, a transmission signal of the Band A from the RFIC 3 input to the input terminal 111 is amplified by the power amplifier 11 and is transmitted through the switch 42, the filter 31, the switch 41A, and the antenna connection terminal 101A to the antenna 2a.

In contrast, in reception of a signal of the Band A in the case of the high power class, as illustrated in FIG. 7, a reception signal of the Band A from the antenna 2b input to the antenna connection terminal 102A is transmitted through the switch 41A, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the high power class, transmission signals and reception signals are separated from each other based on time as well as frequency.

### 2.3.2 Transmission and Reception in Band A in Case of Low Power Class

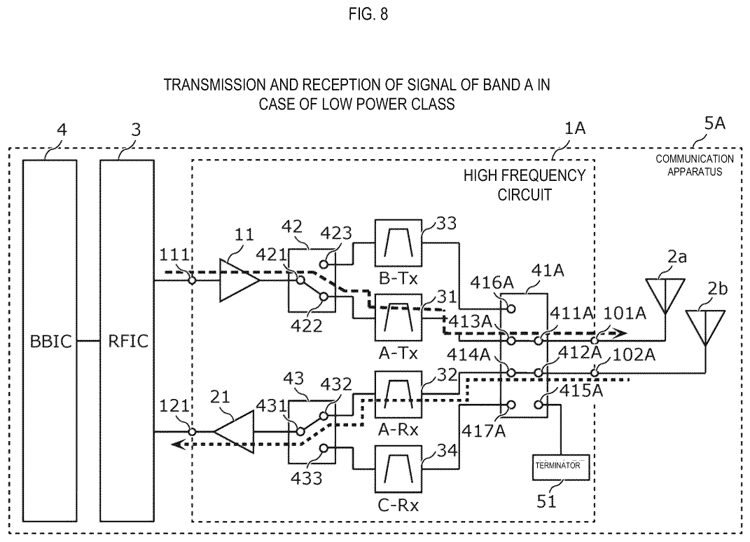

Next, transmission and reception in the Band A in the case of the low power class will be described with reference to FIG. 8. FIG. 8 is a diagram illustrating transmission and reception of signals of the Band A in the case of the low power class in the communication apparatus 5A according to this embodiment.

In the case of the low power class, the RFIC 3 controls each switch of the radio frequency circuit 1A so that transmission and reception can be performed at the same time. Specifically, the switch 41A maintains the third connection (see FIG. 8) in which the terminal 411A is connected to the terminal 413A and the terminal 412A is connected to the terminal 414A.

As a result, in transmission of a signal of the Band A in the case of the low power class, as illustrated in FIG. 8, a transmission signal of the Band A from the RFIC 3 input to the input terminal 111 is amplified by the power amplifier 11 and is transmitted through the switch 42, the filter 31, the switch 41A, and the antenna connection terminal 101A to the antenna 2a.

In contrast, in reception of a signal of the Band A in the case of the low power class, as illustrated in FIG. 8, a reception signal of the Band A from the antenna 2b input to the antenna connection terminal 102A is transmitted through the switch 41A, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the low power class, transmission signals and reception signals are separated from each other based on frequency.

Although the antenna 2a is used for transmission and the antenna 2b is used for reception in FIGS. 6 to 8, the present disclosure is not limited to this configuration. The antenna 2a may be used for reception or may be used for both transmission and reception. Furthermore, the antenna 2b may be used for transmission or may be used for both transmission and reception.

### 2.4 Effects and Others

As described above, the radio frequency circuit 1A according to this embodiment includes the antenna connection terminals 101A and 102A, the input terminal 111, the output terminal 121, the filter 31 having a pass band including at least part of a transmission band of the Band A for FDD, the filter 32 having a pass band including at least part of a reception band of the Band A, and the switch 41A that includes the terminals 411A to 414A. The antenna connection terminal 101A is connected to the terminal 411A. The antenna connection terminal 102A is connected to the terminal 412A. The filter 31 is connected between the terminal 413A and the input terminal 111. The filter 32 is connected between the terminal 414A and the output terminal 121. The switch 41A is configured to switch between first connection, second connection, and third connection. In the first connection, one of the terminals 411A and 412A is connected to the terminal 413A and neither the terminal 411A nor the terminal 412A is connected to the terminal 414A. In the second connection, one of the terminals 411A and 412A is connected to the terminal 414A and neither the terminal 411A nor the terminal 412A is connected to the terminal 413A. In the third connection, one of the terminals 411A and 412A is connected to the terminal 413A and the other one of the terminals 411A and 412A is connected to the terminal 414A.

Accordingly, switching between the first connection and the second connection of the switch 41A is performed temporally. Thus, division and duplex of transmission signals and reception signals of the Band A for FDD can be performed not only based on frequency but also based on time. Therefore, requirements for isolation characteristics between a transmission filter and a reception filter in the Band A can be reduced. That is, design of the filters 31 and 32 can be performed easily, and an increase of loss in the filters 31 and 32 can be suppressed. As a result, output power of the power amplifier 11 can be reduced, and a reduction in noise and an increase in the life of the power supply can be achieved. Furthermore, by maintaining the third connection of the switch 41A, communication speed can be improved compared to the case where switching between the first connection and the second connection is performed temporally.

Furthermore, for example, in the radio frequency circuit 1A according to this embodiment, the switch 41A may temporally switch between the first connection and the second connection in the condition where the high power class that is defined by the maximum output power equal to or higher than the predetermined power is applied to the Band A and may maintain the third connection in the condition where the low power class that is defined by the maximum output power lower than the predetermined power is applied to the Band A.

Accordingly, in the case of the high power class, switching between the first connection and the second connection of the switch 41A is performed temporally. Thus, at the time of high output power when there are higher requirements for isolation characteristics between the filters 31 and 32, the requirements for the isolation characteristics can be reduced. As a result, at the time of high output power, the output power of the power amplifier 11 can be reduced, and effects with respect to a reduction in noise and an increase in the life of the power supply increase. On the contrary, since the third connection of the switch 41A is maintained in the low power class, a reduction in the communication speed can be suppressed at the time of low output power when there are lower requirements for the isolation characteristics.

Furthermore, for example, in the radio frequency circuit 1A according to this embodiment, the switch 41A may further include the terminal 415A that is connected to the terminator 51. In the first connection, the terminal 415A may further be connected to the terminal 414A. In the second connection, the terminal 415A may further be connected to the terminal 413A.

Accordingly, in the first connection and the second connection, the terminals 413A and 414A of the switch 41A can be terminated when these terminals are not used for transmission of a radio frequency signal, and a further improvement in the isolation characteristics can be achieved.

Furthermore, for example, the radio frequency circuit 1A according to this embodiment may further include the power amplifier 11 that is connected between the filter 31 and the input terminal 111.

Accordingly, since the power amplifier 11 is included in the radio frequency circuit 1A, amplification of a transmission signal can be implemented in the radio frequency circuit 1A.

Furthermore, for example, the radio frequency circuit 1A according to this embodiment may further include the filter 33 having a pass band including at least part of a transmission band of the Band B and the switch 42 that is connected between the power amplifier 11 and the filters 31 and 33. The switch 41A may further include the terminal 416A that is connected to the filter 33. In this case, the switch 42 may be configured to switch between connection between the power amplifier 11 and the filter 31 and connection between the power amplifier 11 and the filter 32.

Accordingly, the power amplifier 11 is connected to the filters 31 and 33 with the switch 42 interposed therebetween. Thus, the power amplifier 11 can be shared by the Bands A and B, which contributes to a reduction in the size of the communication apparatus 5A.

Furthermore, for example, the radio frequency circuit 1A according to this embodiment may further include the low noise amplifier 21 that is connected between the filter 32 and the output terminal 121.

Accordingly, since the low noise amplifier 21 is included in the radio frequency circuit 1A, amplification of a reception signal can be implemented in the radio frequency circuit 1A.

Furthermore, for example, the radio frequency circuit 1A according to this embodiment may further include the filter 34 having a pass band including at least part of a reception band of the Band C and the switch 43 that is connected between the low noise amplifier 21 and the filters 32 and 34. The switch 41A may further include the terminal 417A that is connected to the filter 34. In this case, the switch 43 may be configured to switch between connection between the low noise amplifier 21 and the filter 32 and connection between the low noise amplifier 21 and the filter 34.

Accordingly, the low noise amplifier 21 is connected to the filters 32 and 34 with the switch 43 interposed therebetween. Thus, the low noise amplifier 21 can be shared by the Bands A and C, which contributes to a reduction in the size of the communication apparatus 5A.

Furthermore, the communication apparatus 5A according to this embodiment includes the RFIC 3 that processes a radio frequency signal and the radio frequency circuit 1A that transfers the radio frequency signal between the RFIC 3 and the antennas 2a and 2b.

Accordingly, effects of the radio frequency circuit 1A described above can also be achieved in the communication apparatus 5A.

### Third Embodiment

Next, a third embodiment will be described. This embodiment is a modification of the first embodiment and is different from the first embodiment mainly in that a capacitor is connected to the switch 41 in the first embodiment (a switch 41B in this embodiment). Features of this embodiment that are different from the first embodiment will be mainly described below with reference to drawings.

### 3.1 Circuit Configuration of Communication Apparatus 5B

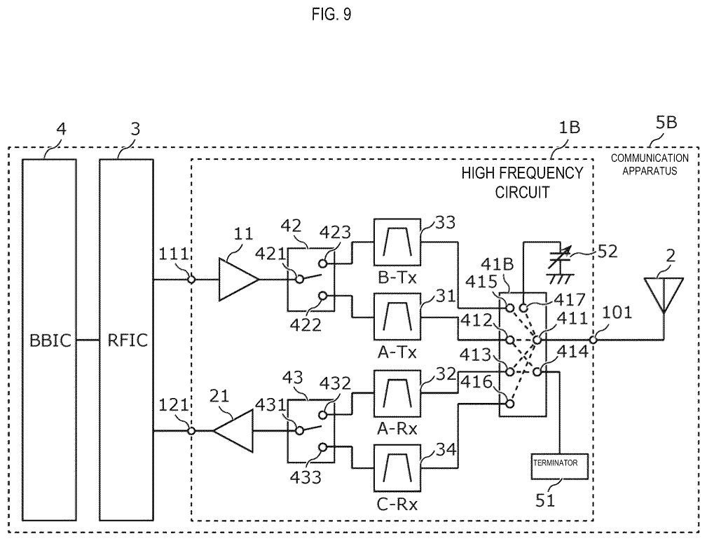

FIG. 9 is a circuit configuration diagram of a communication apparatus 5B according to this embodiment. The communication apparatus 5B according to this embodiment is similar to the communication apparatus 5 according to the first embodiment with exception that the communication apparatus 5B includes a radio frequency circuit 1B instead of the radio frequency circuit 1. Therefore, description of the communication apparatus 5B will be omitted.

### 3.2 Circuit Configuration of Radio Frequency Circuit 1B

Next, a circuit configuration of the radio frequency circuit 1B will be described with reference to FIG. 9. The radio frequency circuit 1B includes the power amplifier 11, the low noise amplifier 21, the filters 31 to 34, the switches 41B, 42, and 43, the terminator 51, a capacitor 52, the antenna connection terminal 101, the input terminal 111, and the output terminal 121. Features of component elements of the radio frequency circuit 1B that are different from those of the radio frequency circuit 1 in FIG. 1 will be mainly described below.

The switch 41B is an example of a first switch and is connected between the antenna connection terminal 101 and the filters 31 to 34. Specifically, the switch 41B includes terminals 411 to 417. The terminal 417 is an example of a seventh terminal and is connected to the capacitor 52.

In this connection arrangement, the switch 41B is capable of, for example, based on a control signal from the RFIC 3, connecting the terminals 411 and 414 to the terminals 412, 413, 415, 416, and 417. The switch 41B is a switch circuit of a multi-connection type.

Specifically, the switch 41B is capable of switching at least between first connection, second connection, and third connection. In the first connection, the terminal 411 is connected to the terminals 412 and 417 and the terminal 411 is not connected to the terminal 413. In this case, the terminal 414 may be connected to the terminal 413 as desired. In the second connection, the terminal 411 is not connected to the terminal 412 and the terminal 411 is connected to the terminals 413 and 417. In this case, the terminal 414 may be connected to the terminal 412 as desired. In the third connection, the terminal 411 is connected to the terminals 412 and 413 at the same time.

In this embodiment, in the condition where the first power class is applied to the Band A, the switch 41B is capable of temporally switching between the first connection and the second connection, as in the first embodiment. Furthermore, in the condition where the second power class is applied to the Band A, the switch 41B is capable of maintaining the third connection.

The capacitor 52 is a variable capacitor. The capacitor 52 is connected between the terminal 417 of the switch 41B and the ground and is capable of compensating for the parasitic capacitance of a filter that can be connected to the terminal 411 in the case where the filter is not connected to the terminal 411. For example, in the first connection, the capacitor 52 is capable of compensating for the parasitic capacitance of at least one of the filters 32 to 34 that are not connected to the terminal 411. Furthermore, for example, in the second connection, the capacitor 52 is capable of compensating for the parasitic capacitance of at least one of the filters 31, 33, and 34 that are not connected to the terminal 411.

A DTC (Digital Tunable Capacitor) may be used as the capacitor 52. However, the capacitor 52 is not limited to a DTC. The electrostatic capacitance of the capacitor 52 is not necessarily variable.

### 3.3 Transmission and Reception in Band A in Case of Each Power Class

Next, transmission and reception in the Band A in the case of each power class in the communication apparatus 5B according to this embodiment will be described.

### 3.3.1 Transmission and Reception in Band A in Case of High Power Class

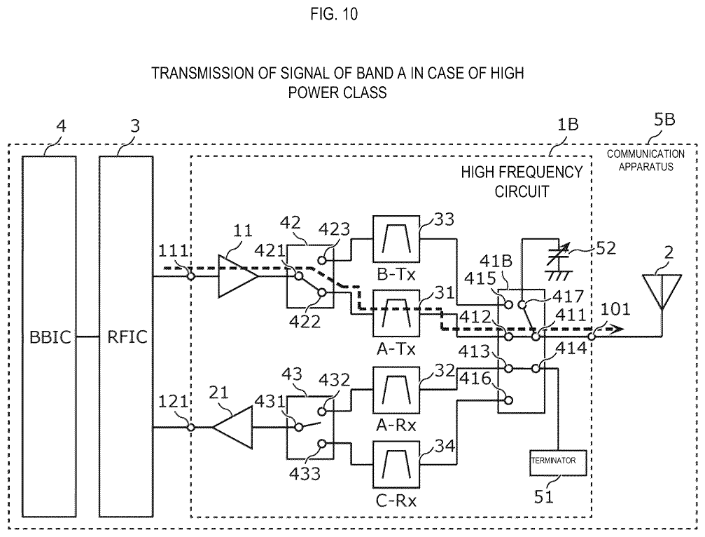

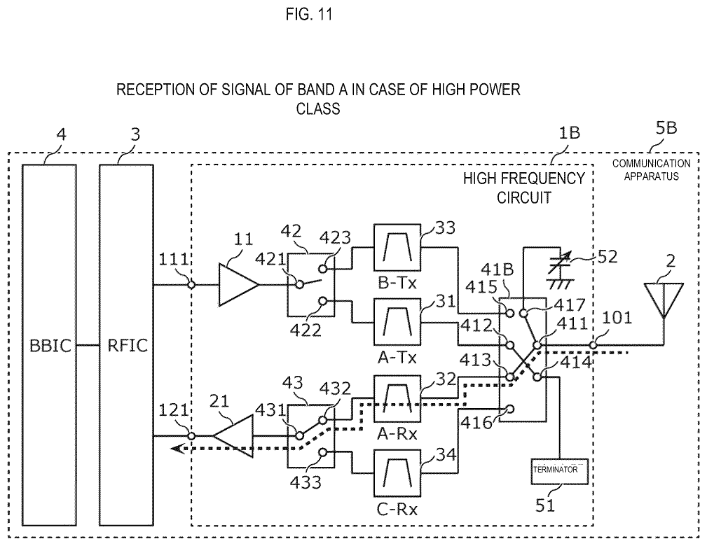

First, transmission and reception in the Band A in the case of the high power class will be described with reference to FIGS. 10 and 11. FIG. 10 is a diagram illustrating transmission of a signal of the Band A in the case of the high power class in the communication apparatus 5B according to this embodiment. FIG. 11 is a diagram illustrating reception of a signal of the Band A in the case of the high power class in the communication apparatus 5B according to this embodiment.

In the case of the high power class, the RFIC 3 controls each switch of the radio frequency circuit 1B so that switching between transmission and reception can be performed in an exclusive manner. Specifically, the switch 41B switches between the first connection (see FIG. 10) in which the terminal 411 is connected to the terminals 412 and 417 and the terminal 414 is connected to the terminal 413 and the second connection (see FIG. 11) in which the terminal 411 is connected to the terminals 413 and 417 and the terminal 414 is connected to the terminal 412. Connection between the terminal 414 and the terminal 413 in the first connection and connection between the terminal 414 and the terminal 412 in the second connection are not essential but are optional.

As a result, in transmission of a signal of the Band A in the case of the high power class, as illustrated in FIG. 10, a transmission signal of the Band A from the RFIC 3 input to the input terminal 111 is amplified by the power amplifier 11 and is transmitted through the switch 42, the filter 31, the switch 41B, and the antenna connection terminal 101 to the antenna 2.

In contrast, in reception of a signal of the Band A in the case of the high power class, as illustrated in FIG. 11, a reception signal of the Band A from the antenna 2 input to the antenna connection terminal 101 is transmitted through the switch 41B, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the high power class, transmission signals and reception signals are separated from each other based on time as well as frequency.

### 3.3.2 Transmission and Reception in Band A in Case of Low Power Class

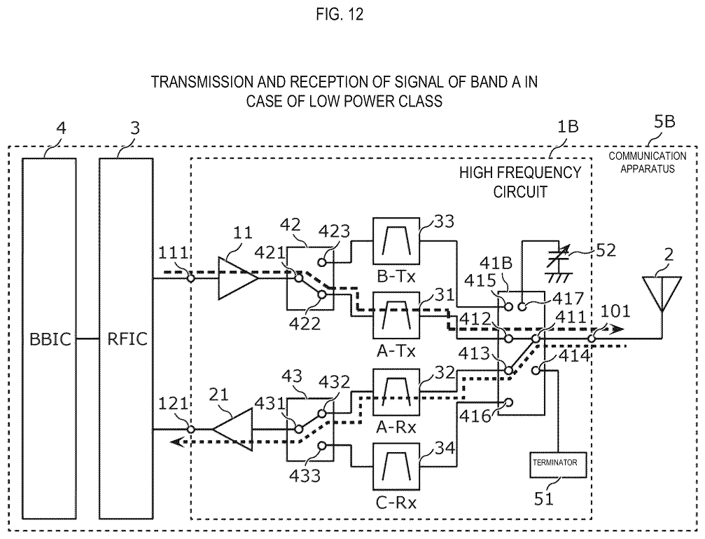

Next, transmission and reception in the Band A in the case of the low power class will be described with reference to FIG. 12. FIG. 12 is a diagram illustrating transmission and reception of signals of the Band A in the case of the low power class in the communication apparatus 5B according to this embodiment.

In the case of the low power class, the RFIC 3 controls each switch of the radio frequency circuit 1B so that transmission and reception can be performed at the same time. Specifically, the switch 41B maintains the third connection (see FIG. 12) in which the terminal 411 is connected to the terminal 412 and the terminal 411 is connected to the terminal 413.

As a result, in transmission of a signal of the Band A in the case of the low power class, as illustrated in FIG. 12, a transmission signal of the Band A from the RFIC 3 input to the input terminal 111 is amplified by the power amplifier 11 and is transmitted through the switch 42, the filter 31, the switch 41B, and the antenna connection terminal 101 to the antenna 2.

In contrast, in reception of a signal of the Band A in the case of the low power class, as illustrated in FIG. 12, a reception signal of the Band A from the antenna 2 input to the antenna connection terminal 101 is transmitted through the switch 41B, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the low power class, transmission signals and reception signals are separated from each other based on frequency.

### 3.4 Effects and Others

As described above, in the radio frequency circuit 1B according to this embodiment, the switch 41B may further include the terminal 417. The radio frequency circuit 1B may further include the capacitor 52 that is connected between the terminal 417 and the ground. In the first connection, the terminal 411 may further be connected to the terminal 417.

Accordingly, in the first connection in which the filter 41 is connected to the terminal 411 and the filter 42 is not connected to the terminal 411, by connecting the capacitor 52 to the terminal 411, the parasitic capacitance of the filter 42 can be compensated for. Thus, variations in load impedance of the filter 41 can be reduced, and variations in characteristics of the filter 41 can be reduced.

Furthermore, for example, in the radio frequency circuit 1B according to this embodiment, the capacitor 52 may be a variable capacitor. In the second connection, the terminal 411 may further be connected to the terminal 417.

Accordingly, in the second connection in which the filter 42 is connected to the terminal 411 and the filter 41 is not connected to the terminal 411, by connecting the capacitor 52 to the terminal 411, parasitic capacitance of the filter 41 can be compensated for. Thus, variations in load impedance of the filter 42 can be reduced, and variations in characteristics of the filter 42 can be reduced.

### Fourth Embodiment

Next, a fourth embodiment will be described. This embodiment is a modification of the second embodiment and is different from the second embodiment mainly in that a capacitor is connected to the switch 41A in the second embodiment (a switch 41C in this embodiment). Features of this embodiment that are different from the second embodiment will be mainly described below with reference to drawings.

### 4.1 Circuit Configuration of Communication Apparatus 5C

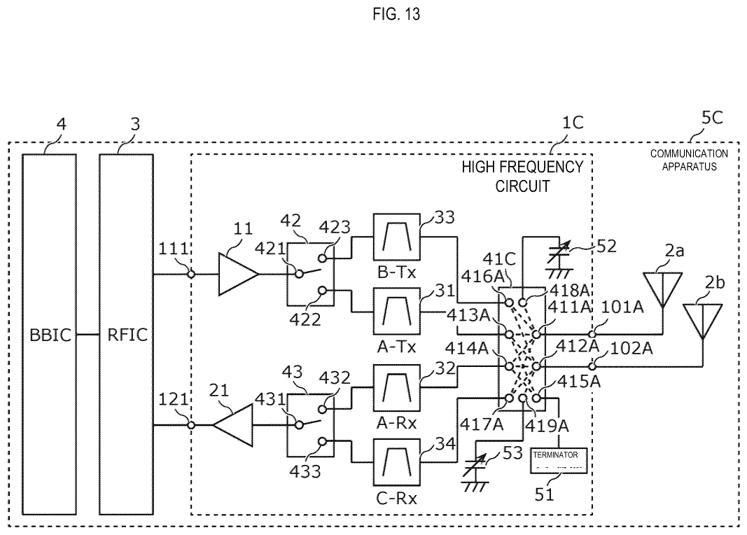

FIG. 13 is a circuit configuration diagram of a communication apparatus 5C according to this embodiment. The communication apparatus 5C according to this embodiment is similar to the communication apparatus 5A according to the second embodiment with exception that the communication apparatus 5C includes a radio frequency circuit 1C instead of the radio frequency circuit 1A. Therefore, description of the communication apparatus 5C will be omitted.

### 4.2 Circuit Configuration of Radio Frequency Circuit 1C

Next, a circuit configuration of the radio frequency circuit 1C will be described with reference to FIG. 13. The radio frequency circuit 1C includes the power amplifier 11, the low noise amplifier 21, the filters 31 to 34, the switches 41C, 42, and 43, the terminator 51, capacitors 52 and 53, the antenna connection terminals 101A and 102A, the input terminal 111, and the output terminal 121. Features of component elements of the radio frequency circuit 1C that are different from those of the radio frequency circuit 1A in FIG. 5 will be mainly described below.

The switch 41C is an example of a first switch and is connected between the antenna connection terminals 101A and 102A and the filters 31 to 34. Specifically, the switch 41C includes terminals 411A to 419A. The terminal 418A is an example of an eighth terminal and is connected to the capacitor 52. The terminal 419A is an example of a ninth terminal and is connected to the capacitor 53.

In this connection arrangement, the switch 41C is capable of, for example, based on a control signal from the RFIC 3, connecting the terminals 411A, 412A, and 415A to the terminals 413A, 414A, and 416A to 419A. The switch 41C is a switch circuit of a multi-connection type.

Specifically, the switch 41C is capable of switching at least between first connection, second connection, and third connection. In the first connection, only one of the terminals 411A and 412A is connected to the terminals 413A and 418A and neither the terminal 411A nor 412A is connected to the terminal 414A. In this case, the terminal 415A may be connected to the terminal 414A as desired. In the second connection, neither the terminal 411A nor the terminal 412A is connected to the terminal 413A and only one of the terminals 411A and 412A is connected to the terminals 414A and 419A. In this case, the terminal 415A may be connected to the terminal 413A as desired. In the third connection, only one of the terminals 411A and 412A is connected to the terminals 413A and 418A and the other one of the terminals 411A and 412A is connected to the terminals 414A and 419A.

In this embodiment, in the condition where the first power class is applied to the Band A, the switch 41C is capable of temporally switching between the first connection and the second connection, as in the second embodiment. Furthermore, in the condition where the second power class is applied to the Band A, the switch 41C is capable of maintaining the third connection.

The capacitor 52 is an example of a first capacitor and is a variable capacitor. The capacitor 52 is connected between the terminal 418A of the switch 41C and the ground and is capable of compensating for the parasitic capacitance of a filter that can be connected to the terminal 411A in the case where the filter is not connected to the terminal 411A. For example, in the first connection, the capacitor 52 is capable of compensating for the parasitic capacitance of at least one of the filters 32 to 34 that are not connected to the terminal 411A.

The capacitor 53 is an example of a second capacitor and is a variable capacitor. The capacitor 53 is connected between the terminal 419A of the switch 41C and the ground and is capable of compensating for the parasitic capacitance of a filter that can be connected to the terminal 412A in the case where the filter is not connected to the terminal 412A. For example, in the second connection, the capacitor 53 is capable of compensating for the parasitic capacitance of at least one of the filters 31, 33, and 34 that are not connected to the terminal 412A.

DTCs may be used as the capacitors 52 and 53. However, the capacitors 52 and 53 are not limited to DTCs. The electrostatic capacitance of the capacitor 52 and/or the capacitor 53 is not necessarily variable.

### 4.3 Transmission and Reception in Band A in Case of Each Power Class

Next, transmission and reception in the Band A in the case of each power class in the communication apparatus 5C according to this embodiment will be described.

### 4.3.1 Transmission and Reception in Band A in Case of High Power Class

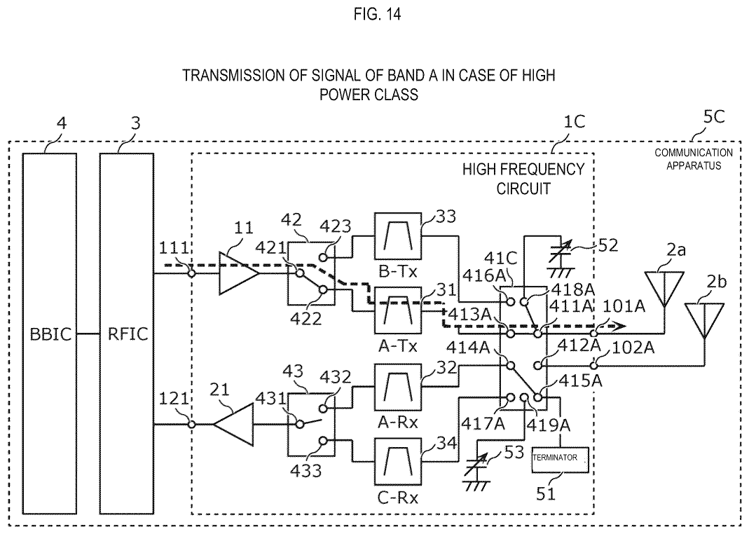

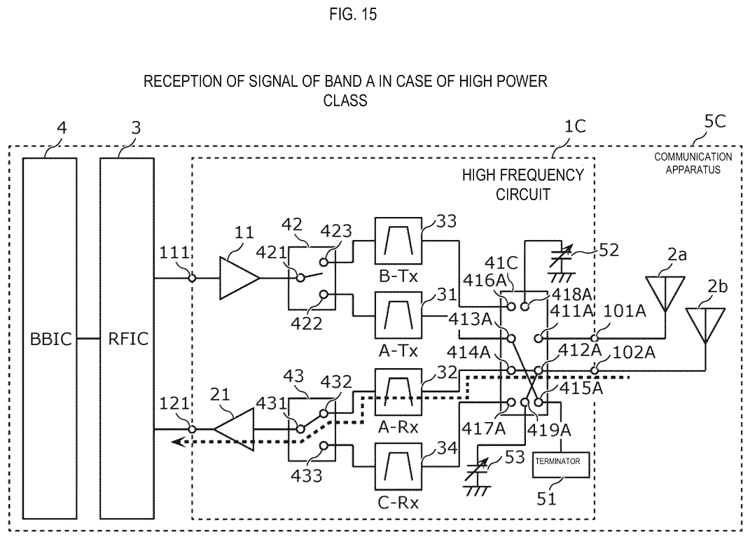

First, transmission and reception in the Band A in the case of the high power class will be described with reference to FIGS. 14 and 15. FIG. 14 is a diagram illustrating transmission of a signal of the Band A in the case of the high power class in the communication apparatus 5C according to this embodiment. FIG. 15 is a diagram illustrating reception of a signal of the Band A in the case of the high power class in the communication apparatus 5C according to this embodiment.

In the case of the high power class, the RFIC 3 controls each switch of the radio frequency circuit 1C so that switching between transmission and reception can be performed in an exclusive manner. Specifically, the switch 41C switches between the first connection (see FIG. 14) in which the terminal 411A is connected to the terminals 413A and 418A and the terminal 415A is connected to the terminal 414A and the second connection (see FIG. 15) in which the terminal 412A is connected to the terminals 414A and 419A and the terminal 415A is connected to the terminal 413A. Connection between the terminal 415A and the terminal 414A in the first connection and connection between the terminal 415A and the terminal 413A in the second connection are not essential but are optional.

As a result, in transmission of a signal of the Band A in the case of the high power class, as illustrated in FIG. 14, a transmission signal of the Band A from the RFIC 3 input to the input terminal 111 is amplified by the power amplifier 11 and is transmitted through the switch 42, the filter 31, the switch 41C, and the antenna connection terminal 101A to the antenna 2a.

In contrast, in reception of a signal of the Band A in the case of the high power class, as illustrated in FIG. 15, a reception signal of the Band A from the antenna 2b input to the antenna connection terminal 102A is transmitted through the switch 41C, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the high power class, transmission signals and reception signals are separated from each other based on time as well as frequency.

### 4.3.2 Transmission and Reception in Band A in Case of Low Power Class

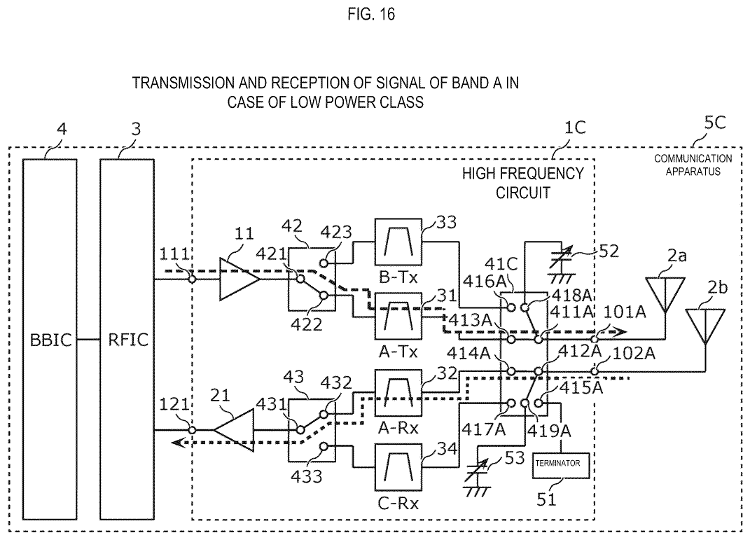

Next, transmission and reception in the Band A in the case of the low power class will be described with reference to FIG. 16. FIG. 16 is a diagram illustrating transmission and reception of signals of the Band A in the case of the low power class in the communication apparatus 5C according to this embodiment.

In the case of the low power class, the RFIC 3 controls each switch of the radio frequency circuit 1C so that transmission and reception can be performed at the same time. Specifically, the switch 41C maintains the third connection (see FIG. 16) in which the terminal 411A is connected to the terminals 413A and 418A and the terminal 412A is connected to the terminals 414A and 419A.

As a result, in transmission of a signal of the Band A in the case of the low power class, as illustrated in FIG. 16, a transmission signal of the Band A from the RFIC 3 input to the input terminal 111 is amplified by the power amplifier 11 and is transmitted through the switch 42, the filter 31, the switch 41C, and the antenna connection terminal 101A to the antenna 2a.

In contrast, in reception of a signal of the Band A in the case of the low power class, as illustrated in FIG. 16, a reception signal of the Band A from the antenna 2b input to the antenna connection terminal 102A is transmitted through the switch 41C, the filter 32, and the switch 43 to the low noise amplifier 21, is amplified by the low noise amplifier 21, and is transmitted through the output terminal 121 to the RFIC 3.

As described above, in transmission and reception of signals of the Band A for FDD in the case of the low power class, transmission signals and reception signals are separated from each other based on frequency.

### 4.4 Effects and Others

As described above, in the radio frequency circuit 1C according to this embodiment, the switch 41C may further include the terminal 418A. The radio frequency circuit 1C may further include the capacitor 52 that is connected between the terminal 418A and the ground. In the first connection and the third connection, the terminal 411A may further be connected to the terminal 418A.

Accordingly, in the first connection and the third connection in which the filter 41 is connected to the terminal 411A and the filter 42 is not connected to the terminal 411A, by connecting the capacitor 52 to the terminal 411A, the parasitic capacitance of the filter 42 can be compensated for. Thus, variations in the load impedance of the filter 41 can be reduced, and variations in the characteristics of the filter 41 can be reduced.

Furthermore, for example, in the radio frequency circuit 1C according to this embodiment, the switch 41C may further include the terminal 419A. The radio frequency circuit 1C may further include the capacitor 53 that is connected between the terminal 419A and the ground. In the second connection and third connection, the terminal 411A may further be connected to the terminal 419A.

Accordingly, in the second connection and the third connection in which the filter 42 is connected to the terminal 412A and the filter 41 is not connected to the terminal 412A, by connecting the capacitor 53 to the terminal 412A, the parasitic capacitance of the filter 41 can be compensated for. Thus, variations in the load impedance of the filter 42 can be reduced, and variations in the characteristics of the filter 42 can be reduced.

### Other Embodiments

The radio frequency circuit and the communication apparatus according to the present disclosure have been described above based on embodiments. However, the radio frequency circuit and the communication apparatus according to the present disclosure are not limited to the embodiments described above. Other embodiments implemented by combining desired component elements in embodiments described above, modifications obtained by making various changes conceivable by those skilled in the art to the embodiments described above without departing from the gist of the present disclosure, and various types of equipment including a radio frequency circuit described above are also included in the present disclosure.

For example, in the circuit configuration of a radio frequency circuit according to each of the embodiments described above, a circuit element, a wire, and the like may be inserted between circuit elements and paths connecting signal paths disclosed in drawings. For example, an impedance matching circuit may be inserted between a power amplifier and a filter and/or between a low noise amplifier and a filter.

Although a power class is used as a condition for switching whether or not to temporally separate between transmission signals and reception signals for an FDD band in each of the embodiments described above, the power class is not necessarily used. For example, switching as to whether or not to temporally separate between transmission signals and reception signals for an FDD band may be performed based on the signal to noise ratio of a reception signal.

Features of a radio frequency circuit and a communication apparatus described above based on each of the foregoing embodiments will be described below.

<1> A radio frequency circuit comprising:
an antenna connection terminal; an input terminal; an output terminal;
a first filter having a pass band including at least part of a transmission band of a first band for frequency division duplex;
a second filter having a pass band including at least part of a reception band of the first band; and
a first switch that includes a first terminal, a second terminal, and a third terminal,
wherein the antenna connection terminal is connected to the first terminal,
wherein the first filter is connected between the second terminal and the input terminal,
wherein the second filter is connected between the third terminal and the output terminal,
wherein the first switch is configured to switch between first connection, second connection, and third connection,
wherein in the first connection, the first terminal is connected to the second terminal and the first terminal is not connected to the third terminal,
wherein in the second connection, the first terminal is connected to the third terminal and the first terminal is not connected to the second terminal, and
wherein in the third connection, the first terminal is connected to the second terminal and the third terminal at the same time.

<2> The radio frequency circuit according to <1>, wherein the first switch
temporally switches between the first connection and the second connection in a condition where a first power class that is defined by a maximum output power equal to or higher than a predetermined power is applied to the first band, and
maintains the third connection in a condition where a second power class that is defined by a maximum output power lower than the predetermined power is applied to the first band.

<3> The radio frequency circuit according to <1> or <2>,
wherein the first switch further includes a fourth terminal that is connected to a terminator,
wherein in the first connection, the fourth terminal is further connected to the third terminal, and
wherein in the second connection, the fourth terminal is further connected to the second terminal.

<4> The radio frequency circuit according to any one of <1>to <3>, further comprising a power amplifier that is connected between the first filter and the input terminal.

<5> The radio frequency circuit according to <4>, further comprising:
a third filter having a pass band including at least part of a transmission band of a second band; and
a second switch that is connected between the power amplifier, the first filter, and the third filter,
wherein the first switch further includes a fifth terminal that is connected to the third filter.

<6> The radio frequency circuit according to <5>, wherein the second switch is configured to switch between connection between the power amplifier and the first filter and connection between the power amplifier and the third filter.

<7> The radio frequency circuit according to any one of <1> to <6>, further comprising a low noise amplifier that is connected between the second filter and the output terminal.

<8> The radio frequency circuit according to <7>, further comprising:
a fourth filter having a pass band including at least part of a reception band of a third band; and
a third switch that is connected between the low noise amplifier, the second filter, and the fourth filter,
wherein the first switch further includes a sixth terminal that is connected to the fourth filter.

<9> The radio frequency circuit according to <8>, wherein the third switch is configured to switch between connection between the low noise amplifier and the second filter and connection between the low noise amplifier and the fourth filter.

<10> A communication apparatus comprising:
a signal processing circuit that processes a radio frequency signal; and
the radio frequency circuit according to any one of <1> to <9> that transmits the radio frequency signal between the signal processing circuit and an antenna.

<11> A radio frequency circuit comprising:
a first antenna connection terminal; a second antenna connection terminal, an input terminal; an output terminal;
a first filter having a pass band including at least part of a transmission band of a first band for frequency division duplex;
a second filter having a pass band including at least part of a reception band of the first band; and
a first switch that includes a first terminal, a second terminal, a third terminal, and a fourth terminal,
wherein the first antenna connection terminal is connected to the first terminal,
wherein the second antenna connection terminal is connected to the second terminal,
wherein the first filter is connected between the third terminal and the input terminal,
wherein the second filter is connected between the fourth terminal and the output terminal,
wherein the first switch is configured to switch between first connection, second connection, and third connection,
wherein in the first connection, one of the first terminal and the second terminal is connected to the third terminal and neither the first terminal nor the second terminal is connected to the fourth terminal,
wherein in the second connection, one of the first terminal and the second terminal is connected to the fourth terminal and neither the first terminal nor the second terminal is connected to the third terminal, and
wherein in the third connection, one of the first terminal and the second terminal is connected to the third terminal and the other one of the first terminal and the second terminal is connected to the fourth terminal.

<12> The radio frequency circuit according to <11>, wherein the first switch
temporally switches between the first connection and the second connection in a condition where a first power class that is defined by a maximum power equal to or higher than a predetermined maximum power is applied to the first band, and
maintains the third connection in a condition where a second power class that is defined by a maximum power lower than the predetermined maximum power is applied to the first band.

<13> The radio frequency circuit according to <11> or <12>, wherein the first switch further includes a fifth terminal that is connected to a terminator,
wherein in the first connection, the fifth terminal is further connected to the fourth terminal, and
wherein in the second connection, the fifth terminal is further connected to the third terminal.

<14> The radio frequency circuit according to any one of <11> to <13>, further comprising a power amplifier that is connected between the first filter and the input terminal.

<15> The radio frequency circuit according to <14>, further comprising:
a third filter having a pass band including at least part of a transmission band of a second band; and
a second switch that is connected between the power amplifier, the first filter, and the third filter,
wherein the first switch further includes a sixth terminal that is connected to the third filter.

<16> The radio frequency circuit according to <15>, wherein the second switch is configured to switch between connection between the power amplifier and the first filter and connection between the power amplifier and the third filter.

<17> The radio frequency circuit according to any one of <11> to <16>, further comprising a low noise amplifier that is connected between the second filter and the output terminal.

<18> The radio frequency circuit according to <17>, further comprising:
a fourth filter having a pass band including at least part of a reception band of a third band; and
a third switch that is connected between the low noise amplifier, the second filter, and the fourth filter,
wherein the first switch further includes a seventh terminal that is connected to the fourth filter.

<19> The radio frequency circuit according to <18>, wherein the third switch is configured to switch between connection between the low noise amplifier and the second filter and connection between the low noise amplifier and the fourth filter.

<20> A communication apparatus comprising:
a signal processing circuit that processes a radio frequency signal; and
the radio frequency circuit according to any one of <11> to <19> that transmits the radio frequency signal between the signal processing circuit and an antenna.

### INDUSTRIAL APPLICABILITY

The present disclosure is widely usable as a radio frequency circuit arranged in a front end section for communication equipment such as a mobile phone.

### REFERENCE SIGNS LIST

1, 1A, 1B, 1C radio frequency circuit
2, 2a, 2b antenna
3 RFIC
4 BBIC
5, 5A, 5B, 5C communication apparatus
11 power amplifier
21 low noise amplifier
31, 32, 33, 34 filter
41, 41A, 41B, 41C, 42, 43 switch
51 terminator
52, 53 capacitor
101, 101A, 102A antenna connection terminal
111 input terminal
121 output terminal
411, 411A, 412, 412A, 413, 413A, 414, 414A, 415, 415A, 416, 416A, 417, 417A, 418A, 419A, 421, 422, 423, 431, 432, 433 terminal cm 1. A radio frequency circuit comprising:
an antenna connection terminal; an input terminal; an output terminal;
a first filter having a pass band including at least part of a transmission band of a first band for frequency division duplex;
a second filter having a pass band including at least part of a reception band of the first band; and
a first switch that includes a first terminal, a second terminal, and a third terminal,
wherein the antenna connection terminal is connected to the first terminal,
wherein the first filter is connected between the second terminal and the input terminal,
wherein the second filter is connected between the third terminal and the output terminal,
wherein the first switch is configured to switch between first connection, second connection, and third connection,
wherein in the first connection, the first terminal is connected to the second terminal and the first terminal is not connected to the third terminal,
wherein in the second connection, the first terminal is connected to the third terminal and the first terminal is not connected to the second terminal, and
wherein in the third connection, the first terminal is connected to the second terminal and the third terminal at the same time.

2. The radio frequency circuit according to claim 1,
wherein the first switch
temporally switches between the first connection and the second connection in a condition where a first power class that is defined by a maximum output power equal to or higher than a predetermined power is applied to the first band, and
maintains the third connection in a condition where a second power class that is defined by a maximum output power lower than the predetermined power is applied to the first band.

3. The radio frequency circuit according to claim 2,
wherein the first switch further includes a fourth terminal that is connected to a terminator,
wherein in the first connection, the fourth terminal is further connected to the third terminal, and
wherein in the second connection, the fourth terminal is further connected to the second terminal.

4. The radio frequency circuit according to claim 3, further comprising a power amplifier that is connected between the first filter and the input terminal.

5. The radio frequency circuit according to claim 4, further comprising:
a third filter having a pass band including at least part of a transmission band of a second band; and
a second switch that is connected between the power amplifier, the first filter, and the third filter,
wherein the first switch further includes a fifth terminal that is connected to the third filter.

6. The radio frequency circuit according to claim 5, further comprising:
a low noise amplifier that is connected between the second filter and the output terminal.

7. The radio frequency circuit according to claim 6, further comprising:
a fourth filter having a pass band including at least part of a reception band of a third band; and
a third switch that is connected between the low noise amplifier, the second filter, and the fourth filter,
wherein the first switch further includes a sixth terminal that is connected to the fourth filter.

8. The radio frequency circuit according to claim 7,
wherein the first switch further includes a seventh terminal,
wherein the radio frequency circuit further includes a capacitor that is connected between the seventh terminal and a ground, and
wherein in the first connection, the first terminal is further connected to the seventh terminal.

9. The radio frequency circuit according to claim 8,
wherein the capacitor is a variable capacitor, and
wherein in the second connection, the first terminal is further connected to the seventh terminal.

10. A communication apparatus comprising:
a signal processing circuit that processes a radio frequency signal; and
the radio frequency circuit according to claim 1 that transmits the radio frequency signal between the signal processing circuit and an antenna.

11. A radio frequency circuit comprising:
a first antenna connection terminal; a second antenna connection terminal, an input terminal; an output terminal;
a first filter having a pass band including at least part of a transmission band of a first band for frequency division duplex;
a second filter having a pass band including at least part of a reception band of the first band; and
a first switch that includes a first terminal, a second terminal, a third terminal, and a fourth terminal,
wherein the first antenna connection terminal is connected to the first terminal,
wherein the second antenna connection terminal is connected to the second terminal,
wherein the first filter is connected between the third terminal and the input terminal,
wherein the second filter is connected between the fourth terminal and the output terminal,
wherein the first switch is configured to switch between first connection, second connection, and third connection,
wherein in the first connection, one of the first terminal and the second terminal is connected to the third terminal and neither the first terminal nor the second terminal is connected to the fourth terminal,
wherein in the second connection, one of the first terminal and the second terminal is connected to the fourth terminal and neither the first terminal nor the second terminal is connected to the third terminal, and
wherein in the third connection, one of the first terminal and the second terminal is connected to the third terminal and the other one of the first terminal and the second terminal is connected to the fourth terminal.

12. The radio frequency circuit according to claim 11,
wherein the first switch
temporally switches between the first connection and the second connection in a condition where a first power class that is defined by a maximum power equal to or higher than a predetermined maximum power is applied to the first band, and
maintains the third connection in a condition where a second power class that is defined by a maximum power lower than the predetermined maximum power is applied to the first band.

13. The radio frequency circuit according to claim 12,
wherein the first switch further includes a fifth terminal that is connected to a terminator,
wherein in the first connection, the fifth terminal is further connected to the fourth terminal, and
wherein in the second connection, the fifth terminal is further connected to the third terminal.

14. The radio frequency circuit according to claim 13, further comprising a power amplifier that is connected between the first filter and the input terminal.

15. The radio frequency circuit according to claim 14, further comprising:
a third filter having a pass band including at least part of a transmission band of a second band; and
a second switch that is connected between the power amplifier, the first filter, and the third filter,
wherein the first switch further includes a sixth terminal that is connected to the third filter.

16. The radio frequency circuit according to claim 15, further comprising:
a low noise amplifier that is connected between the second filter and the output terminal.

17. The radio frequency circuit according to claim 16, further comprising:
a fourth filter having a pass band including at least part of a reception band of a third band; and
a third switch that is connected between the low noise amplifier, the second filter, and the fourth filter,
wherein the first switch further includes a seventh terminal that is connected to the fourth filter.

18. The radio frequency circuit according to claim 17,
wherein the first switch further includes an eighth terminal,
wherein the radio frequency circuit further includes a first capacitor that is connected between the eighth terminal and a ground, and
wherein in the first connection and the third connection, the first terminal is further connected to the eighth terminal.

19. The radio frequency circuit according to claim 18,
wherein the first switch further includes a ninth terminal,
wherein the radio frequency circuit further includes a second capacitor that is connected between the ninth terminal and the ground, and
wherein in the second connection and the third connection, the first terminal is further connected to the ninth terminal.

20. A communication apparatus comprising:
a signal processing circuit that processes a radio frequency signal; and
the radio frequency circuit according to claim 11 that transmits the radio frequency signal between the signal processing circuit and an antenna.
